(19) United States
(12) Patent Application Publication
(10) Pub. No.: US 2008/0288669 A1
(43) Pub. Date: Nov. 20, 2008

(54) MEMORY CARD ADAPTER AND METHOD FOR STORING DATA ON MEMORY CARD

(75) Inventors: DE-HUA TONG, Shenzhen (TW); SHIH-FANG WONG, Tu-Cheng (TW); ZHAN-WU LI, Shenzhen (CN); LIN-LIN GUO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/927,711

(22) Filed: Oct. 30, 2007

(30) Foreign Application Priority Data
May 18, 2007 (CN) 200710200648.3

(51) Int. Cl. G06F 3/00

(52) U.S. Cl. 710/18; 710/19

(57) ABSTRACT

An adapter for storing data includes a male connector, a first slot, a second slot, a switch circuit, and a controller. The male connector is used for connecting to an electronic device. The first slot is used for connecting a first memory card. The second slot is used for connecting a second memory card. The switch circuit is used for selectively connecting the male connector with the first slot and the second slot. The controller is used for detecting states of the first memory card and the second memory card and controlling the switch circuit to connect the male connector with one of the first slot and the second slot based on detected states.

### BACKGROUND

1. Field of the Invention

This invention generally relates to data storage adapters, and particularly to a memory card adapter and a method for storing data on memory cards.

2. Description of Related Art

Electronic devices, such as digital cameras, mobile phones, and portable audio/video players, are widely used for a variety of applications.

The electronic devices usually include card slots to connect to external memory cards to store data. For example, a digital camera usually includes a card slot for connecting a secure digital (SD) card to store data images. Thus the digital camera is able to store a plurality of images on the SD card even when an internal memory of the digital camera is full.

Generally, an electronic device usually includes only one card slot, thus only one memory card can be inserted into the card slot at one time. Therefore, if a memory card connected to the electronic device is full, the electronic device would not be able to store any more data. To store more data, a user must use another memory card to replace the current memory card or delete some data from the current memory card. However, it takes time to replace the current memory card or delete the data, and makes it inconvenient especially when data must be stored to the memory card as soon as possible.

### SUMMARY

An adapter for storing data includes a male connector for connecting to an electronic device, a first slot connecting a first memory card, a second slot for connecting a second memory card, a switch circuit, and a controller. The switch circuit is used for selectively connecting the male connector with the first slot and the second slot. The controller is used for detecting states of the first memory card and the second memory card and controlling the switch circuit to connect the male connector with one of the first slot and the second slot based on the detected states.

A method for storing data includes: determining whether a first memory card is full; storing data on the first memory card if the first memory card is not full; determining whether a second memory card is full; and storing the data on the second memory card if the second memory card is not full.

Other advantages and novel features will become more apparent from the following detailed description of preferred embodiments when taken in conjunction with the accompanying drawings.

### BRIEF DESCRIPTION OF THE DRAWINGS

Many aspects of the adapter and method can be better understood with reference to the following drawings. The components in the drawings are not necessarily to scale, the emphasis instead being placed upon clearly illustrating the principles of the present adapter and method. Moreover, in the drawings, like reference numerals designate corresponding parts throughout the several views.

FIG. 1 is a schematic diagram of a data storage adapter in accordance with an exemplary embodiment.

FIG. 2 is a block diagram of the data storage adapter of FIG. 1 in accordance with an exemplary embodiment.

FIG. 3 is a procedure of a method for storing data on memory cards.

### DETAILED DESCRIPTION

Reference will now be made to the drawings to describe a preferred embodiment of a data storage adapter and a method for storing data, in detail.

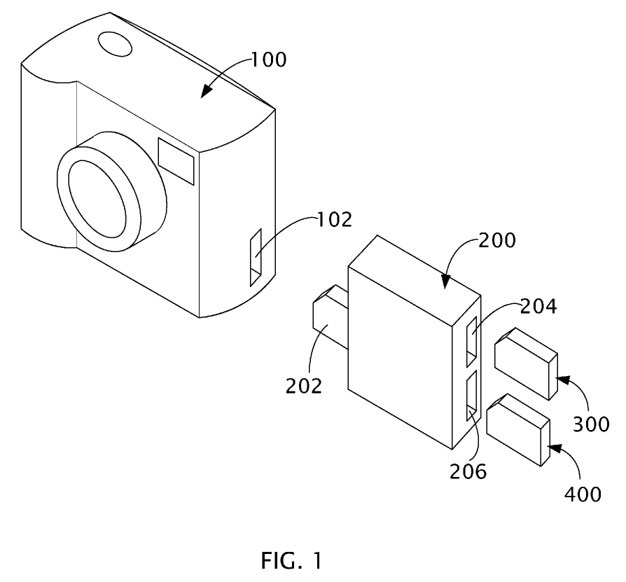

Referring to FIG. 1, a schematic diagram of a data storage adapter 200 is illustrated. The data storage adapter 200 is used for connecting multiple memory cards 300,400 with an electronic device 100 for transmitting and storing data from the electronic device 100 to the memory cards 300, 400. The electronic device 100 includes a card slot 102 for connecting a memory card to store the data. The electronic device 100 can be, for example, but not limited to, a digital camera, a mobile phone, etc.

The data storage adapter 200 includes a male connector 202 for connecting the data storage adapter 200 to the electronic device 100. The male connector 202 conforms to the card slot 102, so that the male connector 202 can be inserted into the card slot 102 of the electronic device 100. The data storage adapter 200 further includes a first slot 204 and a second slot 206 for connecting a first memory card 300 and a second memory card 400 correspondingly. The first memory card 300 and the second memory card 400 can be a same type of memory card, such as secure digital (SD) card or multimedia card (MMC). Moreover, the first memory card 300 and the second memory card 400 can be different types of memory card, for example, the first memory card 300 may be an SD card, and the second memory card 400 may be an MMC card.

When the electronic device 100 stores data into the memory cards, the data can be initially stored into the first memory card 300 via the data storage adapter 200. After the first memory card 300 is full, the data can be stored into the second memory card 400. When the data is being stored into the second memory card 400, the first memory card 300 can be replaced by a third memory card. Thus, after the second memory card 400 is full, the data can be stored into the third memory card. Similarly, when the data is stored into the third memory card, the second memory card 400 can be replaced as well. Therefore, the data storage adapter 200 acts as a storage device that is able to store infinite data via changing memory cards and storing data on the memory cards alternately.

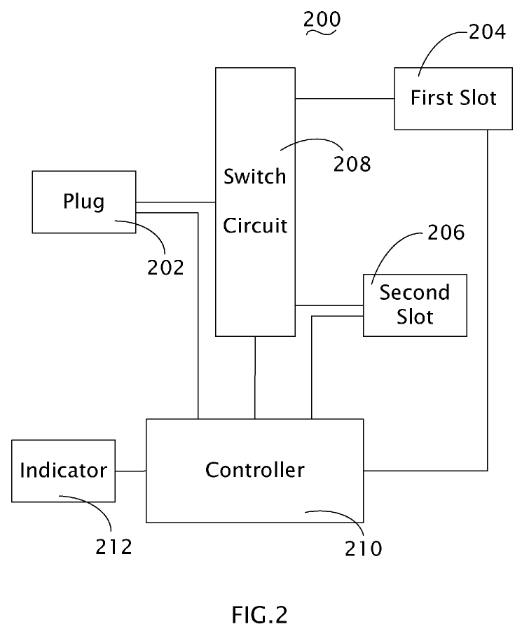

Referring to FIG. 2, a detailed block diagram of the data storage adapter 200 is illustrated. The data storage adapter 200 further includes a switch circuit 208, a controller 210, and an indicator 212.

The switch circuit 208 is connected to the male connector 202, the first slot 204, the second slot 206, and the controller 210 respectively. The switch circuit 208 is configured for selectively connecting the male connector 202 with the first slot 204 and the second slot 206.

The controller 210 is connected to the male connector 202, the first slot 204, the second slot 206, and the switch circuit 208 respectively. The controller 210 is configured for detecting states of the first memory card 300, and the second memory card 400 correspondingly housed in the first slots 204, and the second slot 206, controlling the switch circuit 208 to connect the male connector 202 with the first slot 204 or the second slot 206 based on detected states, so as to correspondingly store the data into the first memory card 300, or the second memory card 400 that is not full.

The indicator 212 is connected to and controlled by the controller 210 for indicating the states of the first memory card 300 and the second memory card 400 housed in the first slot 204 and the second slot 206.

When the data storage adapter 200 is transferring data, that is, when the electronic device 100 stores data via the data storage adapter 200, the data storage adapter 200 detects whether the first memory card 300 housed in the first slot 204 to determine whether the first memory card 300 has free space. If the first memory card 300 has free space, the controller controls the switch circuit 208 to connect the male connector 202 with the first slot 204, thus the electronic device 100 is able to store the data into the first memory card 300 via the data storage adapter 200. If the first memory card 300 is detected to be full and the second memory card 400 is detected to have free space, the controller controls the switch circuit 208 to connect the male connector 202 with the second slot 206, thus the electronic device 100 is able to store the data into the second memory card 400 via the data storage adapter 200. Hence, the first memory card 300 can be replaced even when data is being transferred to the second memory card 400. When the second memory card 400 becomes full, the controller 210 controls the switch circuit 208 to connect the male connector 202 with the first slot 204 again and the data can be stored into a replaced first memory card. The replaced first memory card may be the first memory card 300 with its data uploaded to a computer or a third memory card.

When data is being stored, the indicator 212 indicates the states of the first memory card 300 and the second memory card 400 housed in the first slot 204 and the second slot 206. For example, the indicator 212 includes two light emitting diodes (LEDs) for respectively indicating the states of the first slot 204 and the second slot 206. A first state of the LED, such as an off state of the LED, indicates that the slot for connecting the memory card is empty. A second state of the LED, such as a green state of the LED, indicates that the memory card housed in the slot has free space. A third state of the LED, such as a red state of the LED, indicates that the memory card housed in the slot is full.

The data storage adapter 200 includes two slots for connecting the first memory card 300 and the second memory card 400 accordingly. Thus, after the first memory card 300 is full, the data can be stored into the second memory card 400. Moreover, the electronic device 100 is able to store the data even when the user is replacing one of the memory cards. Further, the data storage adapter 200 can be configured with more than two slots, such as three or four slots.

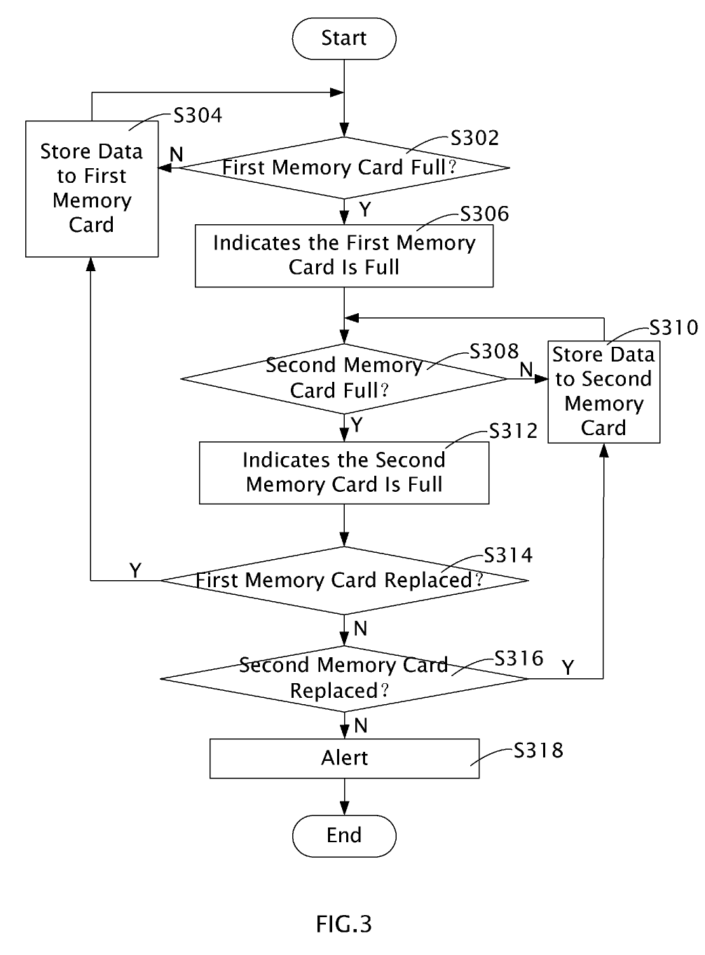

Referring to FIG. 3, a procedure of a method for storing data into memory cards is illustrated.

First, in step S302, the controller 210 detects the state of the first memory card 300 to determine whether the first memory card 300 is full. If the first memory card 300 is not full, the procedure proceeds to step S304 to store the data into the first memory card 300. If the first memory card 300 is full, the procedure proceeds to step S306.

In step S306, the indicator 212 indicates that the first memory card 300 is full. For example, a corresponding LED emits red lights to indicate the first memory card 300 is full.

In step S308, the controller 210 detects the state of the second memory card 400 to determine whether the second memory card 400 is full. If the second memory card 400 is not full, the procedure proceeds to step S310 to store the data into the second memory card 400. If the second memory card 400 is full, the procedure proceeds to step S312.

In step S312, the indicator 212 indicates that the second memory card 400 is full.

In step S314, the controller 210 detects the state of the first memory card 300 to determine whether the first memory card 300 is replaced with the third memory card having free space. If the first memory card 300 is replaced, the procedure goes back to step S304 to store the data into the third memory card, that is, store the data into the replaced first memory card. If the first memory card 300 is not replaced, that is, the first memory card 300 remains in a full state, the procedure proceeds to step S316.

In step S316, the controller 210 detects the state of the second memory card 400 to determine whether the second memory card 400 is replaced with a fourth memory card having free space. If the second memory card 400 is replaced, the procedure goes back to step S310 to store the data into the fourth memory card, that is, store the data into the replaced second memory card. If the second memory card 400 is not replaced, that is, the second memory card 400 remains in a full state, the procedure proceeds to step S318.

In step S318, the controller 210 controls the indicator 212 to send an alert. For example, the controller 210 controls a corresponding LED to flash.

The method for storing data on memory cards detects the states of the memory cards, after one of the memory cards is full, the data can be stored into another memory card.

Take an SD card as an example, the functions of each pin of the SD card are described in the following table:

| Pin | Name | Description |
|---|---|---|
| 1 | CD/DAT3 | Card detection/Connector data line 3 |
| 2 | CMD | Command/Response line |
| 3 | Vss1 | Supply voltage (earth) |
| 4 | Vdd | Power supply |
| 5 | CLK | Clock |
| 6 | Vss2 | Supply voltage |
| 7 | DAT0 | Connector data line 0 |
| 8 | DAT1 | Connector data line 1 |
| 9 | DAT2 | Connector data line 2 |

After the electronic device 100 is powered on, the controller 210 detects the state of the SD card housed in the first slot 204 via pin 1 of the SD card. If the SD card housed in the first slot 204 is not full, the controller 210 controls the switch circuit 208 to connect the male connector 202 with the first slot 204. The switch circuit 208 can be a single pole double throw (SPDT) switch circuit, such as ADG791A of Analog Device, Inc. When the male connector 202 is connected with the first slot 204, the electronic device 100 is able to store the data into the SD card housed in the first slot 204 via the data storage adapter 200. If it is detected that the SD card housed in the first slot 204 is full and the SD card housed in the second slot has free space, the controller 210 controls the switch circuit 208 to connect the male connector 202 with the second slot 206, thus the electronic device 100 is able to store the data into the SD card housed in the second slot 206 via the data storage adapter 200.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. An adapter for storing data on memory cards, comprising:
a male connector for connecting to an electronic device;
a first slot for connecting a first memory card;
a second slot for connecting a second memory card;
a switch circuit for selectively connecting the male connector with the first slot and the second slot; and
a controller for detecting states of the first memory card and the second memory card and controlling the switch circuit to connect the male connector with one of the first slot and the second slot based on detected states.

2. The adapter as claimed in claim 1, wherein the controller is configured for detecting a state of the first memory card, and controlling the switch circuit to connect the male connector with the first slot if the first memory card has free space.

3. The adapter as claimed in claim 2, wherein the controller is configured for controlling the switch circuit to connect the male connector with the second slot if the first memory card is full.

4. The adapter as claimed in claim 3, wherein the controller is configured for controlling the switch circuit to connect the male connector with the first slot if the second memory card is full and the first memory card is replaced with a new memory card.

5. The adapter as claimed in claim 1, further comprising an indicator for indicating the states of the first slot and the second slot.

6. The adapter as claimed in claim 5, wherein the indicator comprises two light emitting diodes for indicating the states of the first slot and the second slot respectively.

7. The adapter as claimed in claim 1, wherein the male connector is shape as a memory card.

8. A method for storing data, comprising:
determining whether a first memory card is full;
storing data on the first memory card if the first memory card is not full;
determining whether a second memory card is full; and
storing the data on the second memory card if the second memory card is not full.

9. The method as claimed in claim 8, further comprising: indicating the first memory card is full if the first memory card is full.

10. The method as claimed in claim 8, further comprising: indicating the second memory card is full if the second memory card is full.

11. The method as claimed in claim 8, further comprising: determining whether the first memory card is replaced with a new memory card if the second memory card is full.

12. The method as claimed in claim 11, further comprising: storing the data on the new memory card if the first memory card is replaced with the new memory card.

13. The method as claimed in claim 1, further comprising: determining whether the second memory card is replaced with the new memory card if the first memory card is not replaced with the new memory card.

14. The method as claimed in claim 13, further comprising: storing the data on the new memory card if the second memory card is replaced with the new memory card.

15. The method as claimed in claim 13, further comprising: sending an alert if the second memory card is not replaced with the new memory card.
